(19) United States
(12) Patent Application Publication
(10) Pub. No.: US 2025/0069457 A1
(43) Pub. Date: Feb. 27, 2025

(54) ENTRANCE MANAGEMENT DEVICE, ENTRANCE MANAGEMENT METHOD, AND PROGRAM STORAGE MEDIUM

(71) Applicant: NEC Corporation, Minato-ku, Tokyo (JP)

(72) Inventor: Kenta TANAKA, Tokyo (JP)

(73) Assignee: NEC Corporation, Minato-ku, Tokyo (JP)

(21) Appl. No.: 18/726,453

(22) PCT Filed: Jan. 31, 2022
(86) PCT No.: PCT/JP2022/003565

§ 371 Date: Jul. 3, 2024

(51) Int. Cl. G07C 9/25

(52) U.S. Cl. CPC G07C 9/25; G07C 2209/02

(57) ABSTRACT

This entry management device is provided with a pre-authentication unit and a notification unit. The pre-authentication unit executes a pre-authentication process of determining whether a person to be authenticated is a registered person, by cross-referencing pre-authentication information regarding the person to be authenticated and registered information for pre-authentication stored in a database. The notification unit determines, using the result of the pre-authentication process, the content to be issued to the person to be authenticated as guidance information, and outputs the guidance information to a display device for displaying the guidance information. The guidance information notifies the person to be authenticated of an authentication process for determining whether the person to be authenticated is permitted to enter a restricted area.

### TECHNICAL FIELD

The present invention relates to a technique for managing entrance into a restricted area where only authorized persons can enter using an authentication technique.

### BACKGROUND ART

For example, a flapper gate is installed at an entrance of a restricted area where only an authorized person can enter, and the entrance to the restricted area may be restricted by the flapper gate. The opening and closing of the flapper gate is controlled using, for example, an authentication technique. That is, information (password, user IDentification (ID), biometric information such as face and fingerprint, and the like) presented by an entrance requester who requests entrance to the restricted area is collated with information on a registrant registered in advance. As a result, in a case where the information presented by the entrance requester (in other words, a person to be authenticated) matches or is similar to the information on the registrant, the entrance requester is determined to be the registrant, and the flapper gate is opened to permit entrance.

PTL 1 (JP 2006-293913 A) discloses a technique of presenting guidance information associated with a person in a case where the person is determined to be a person registered in advance from a face image of an entering/exiting person. In addition, PTL 2 (JP 2005-346345 A) discloses a configuration in which authentication is performed using an authentication number recorded in an IC tag carried by a user when the user enters a venue.

### CITATION LIST

### Patent Literature

PTL 1: JP 2006-293913 A
PTL 2: JP 2005-346345 A

### SUMMARY OF INVENTION

### Technical Problem

Incidentally, in order to perform an authentication process of determining whether to permit entrance to the restricted area, for example, a message (hint information) such as “Please press the middle finger against the reading device” may be issued to the entrance requester who approaches the flapper gate by a display device. That is, there is a case where information desired to be presented to the entrance requester (person to be authenticated) for the authentication process is issued to the entrance requester by the display device on a front side of the flapper gate.

Such display of the hint information is helpful for a person who is not accustomed to the authentication process when passing through the flapper gate, but may cause the following situation. That is, since the hint information is always the same, the entrance requester may get used to the display of the hint information, and in this case, the entrance requester may not see the hint information. In such a situation, it is assumed that information (hereinafter referred to as presentation request information) that needs to be presented by the entrance requester for the authentication process is changed. In this case, the content of the hint information is changed according to the change of the presentation request information, but the entrance requester who is accustomed to the display of the hint information presents the presentation request information before the change without looking at the hint information, and authentication fails. In this case, for example, the entrance requester notices the change in the presentation request information by viewing the hint information again, and presents the presentation request information again. For this reason, since the entrance requester stops in front of the flapper gate, a situation may occur in which the subsequent entrance requester stays in front of the flapper gate.

In addition, there is also a problem that the display of the hint information may give a hint for breaking the authentication to a person (also referred to as an attacker) who tries to pass through the flapper gate by impersonating a registrant.

The present invention has been devised in order to solve the above problems. That is, a main object of the present invention is to provide a technique for avoiding a problem caused by display of guidance information (hint information) while having a function of displaying the guidance information (hint information) for assisting a person who is not accustomed to an authentication process.

### Solution to Problem

In order to achieve the above object, an entrance management device according to the present invention includes, as one aspect thereof,
a pre-authentication unit for executing a pre-authentication process of determining whether a person to be authenticated is a registrant by collating pre-authentication information related to the person to be authenticated for whom it is determined whether the person can enter a restricted area with pre-authentication registration information stored as an authentication registration information in a database storing the authentication registration information indicating the registrant who is permitted to enter the restricted area, and
a notification unit for determining, as guidance information, content to be issued to the person to be authenticated regarding an authentication process of determining whether the person to be authenticated can enter the restricted area, by using a result of the pre-authentication process, and outputting the guidance information toward a display device that displays the guidance information.

Further, an entrance management method according to the present invention as one aspect thereof includes,
by means of a computer,
executing a pre-authentication process of determining whether a person to be authenticated is a registrant by collating pre-authentication information related to the person to be authenticated for whom it is determined whether the person can enter a restricted area with pre-authentication registration information stored in a database storing authentication registration information indicating the registrant who is permitted to enter the restricted area, and
determining, as guidance information, content to be issued to the person to be authenticated regarding an authentication process of determining whether the person to be authenticated can enter the restricted area, by using a result of the pre-authentication process, and outputting the guidance information toward a display device that displays the guidance information.

Further, a program storage medium according to the present invention stores a computer program for causing a computer, as one aspect thereof, to perform,
executing a pre-authentication process of determining whether a person to be authenticated is a registrant by collating pre-authentication information related to the person to be authenticated for whom it is determined whether the person can enter a restricted area with pre-authentication registration information stored in a database storing authentication registration information indicating the registrant who is permitted to enter the restricted area, and
determining, as guidance information, content to be issued to the person to be authenticated regarding an authentication process of determining whether the person to be authenticated can enter the restricted area, using a result of the pre-authentication process, and outputting the guidance information toward a display device that displays the guidance information.

### Advantageous Effects of Invention

According to the present invention, it is possible to avoid a problem caused by display of guidance information (hint information) while having a function of displaying the guidance information (hint information) for assisting a person who is not accustomed to the authentication process.

### BRIEF DESCRIPTION OF DRAWINGS

FIG. 1 is a block diagram illustrating a configuration of an entrance management device according to a first example embodiment of the present invention.

FIG. 2 is a diagram illustrating an entrance management system in which the entrance management device of the first example embodiment is incorporated.

FIG. 3 is a diagram illustrating an example of data referred to by a notification unit in the entrance management device of the first example embodiment.

FIG. 4 is a diagram illustrating an example of another data referred to by the notification unit in the entrance management device of the first example embodiment.

FIG. 5 is a flowchart illustrating an example of an operation in the entrance management device of the first example embodiment.

FIG. 6 is a block diagram illustrating a configuration of an entrance management device according to a second example embodiment of the present invention.

FIG. 7 is a diagram illustrating an example of data referred to by a notification unit in the entrance management device according to the second example embodiment.

FIG. 8 is a diagram illustrating an example of another data referred to by the notification unit in the entrance management device of the second example embodiment.

FIG. 9 is a flowchart illustrating an example of an operation in the entrance management device of the second example embodiment.

FIG. 10 is a diagram illustrating a modification of the entrance management device of the first example embodiment.

FIG. 11 is a diagram illustrating the modification of the entrance management device of the first example embodiment together with FIG. 10.

FIG. 12 is a diagram illustrating the modification of the entrance management device of the first example embodiment together with FIGS. 10 and 11.

FIG. 13 is a block diagram illustrating a configuration of an entrance management device according to another example embodiment of the present invention.

FIG. 14 is a block diagram illustrating a configuration of an entrance management device according to still another example embodiment of the present invention.

FIG. 15 is a block diagram illustrating a configuration of an entrance management device according to yet still another example embodiment of the present invention.

FIG. 16 is a flowchart illustrating an example of an operation of the entrance management device illustrated in FIG. 15.

### EXAMPLE EMBODIMENTS

Hereinafter, example embodiments according to the present invention will be described with reference to the drawings.

### First Example Embodiment

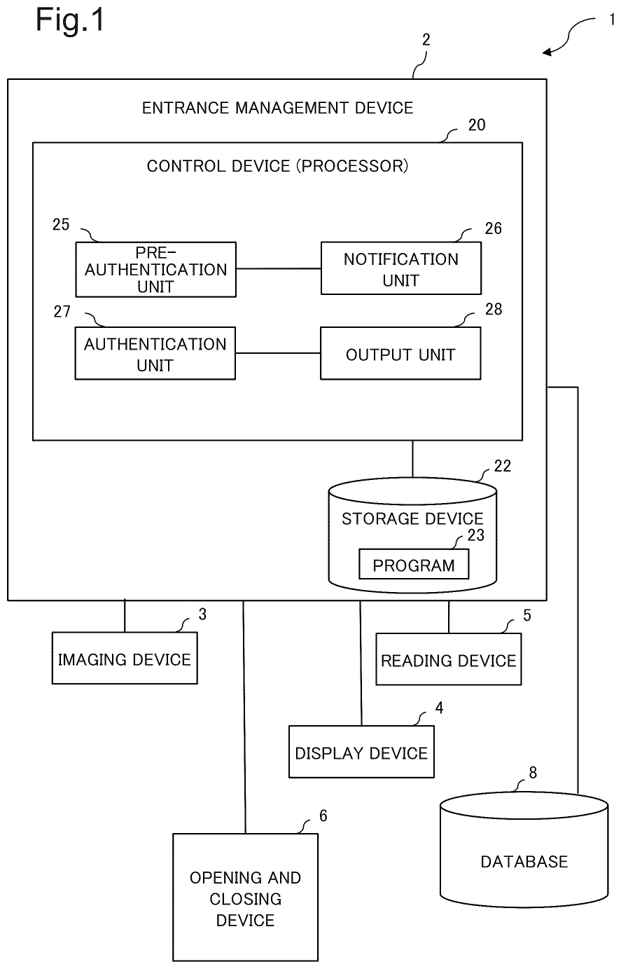

FIG. 1 is a block diagram illustrating a configuration of an entrance management device according to a first example embodiment of the present invention. An entrance management device 2 is a device that is incorporated in an entrance management system 1 and manages entrance to a restricted area. Here, the restricted area is an area where only a person who is permitted to enter can enter.

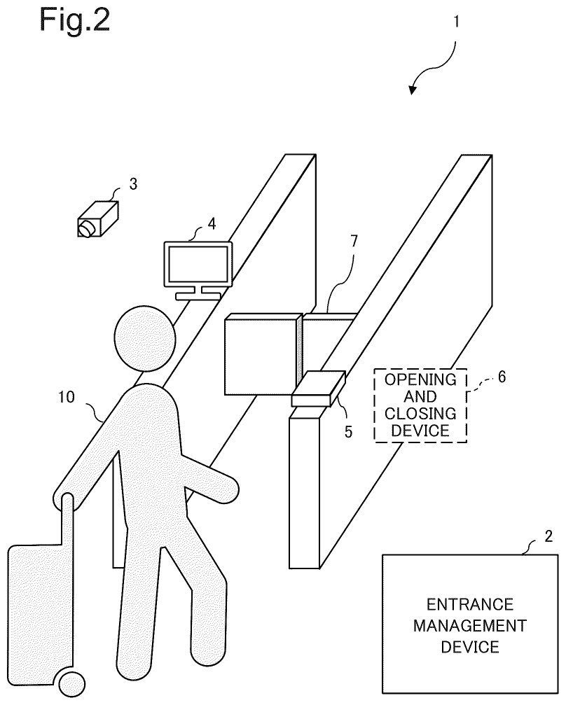

FIG. 2 is a diagram illustrating the entrance management system 1 in which the entrance management device 2 is incorporated. The entrance management system 1 includes the entrance management device 2, an imaging device 3, a display device 4, a reading device 5, an opening and closing device 6, and a flapper gate 7.

The flapper gate 7 is installed at an entrance of the restricted area, and opens or closes the entrance of the restricted area by opening or closing. The opening and closing device 6 is a driving device that opens and closes the flapper gate 7. The opening and closing device 6 opens and closes the flapper gate 7 in accordance with an instruction output from the entrance management device 2.

The imaging device 3 is a device that images a person who is about to enter the restricted area. The entrance management system 1 has a function of determining whether to permit a person who intends to enter the restricted area to enter the restricted area. That is, here, the person who is about to enter the restricted area is a person to be authenticated 10, and it is determined whether to permit entrance into the restricted area. In the entrance management system 1, two types of authentication processes of a pre-authentication process and an authentication process (main authentication process) are executed for the person to be authenticated 10. In the first example embodiment, the imaging device 3 acquires information on the person to be authenticated 10 for use in the pre-authentication process and outputs the information as pre-authentication information. That is, the imaging device 3 adjusts an installation position and an imaging direction so as to be capable of imaging the person to be authenticated 10 and acquiring information on the person to be authenticated 10 for use in the pre-authentication process. For example, in a case where face authentication is performed as the pre-authentication, the installation position and the imaging direction are adjusted so that a face image of the person to be authenticated 10, which is the pre-authentication information for the face authentication, can be acquired. Furthermore, in a case where a gait acceptance is performed as the pre-authentication, the installation position and the imaging direction are adjusted so that a video obtained by imaging a way of walking of the person to be authenticated 10, which is the pre-authentication information for the gait acceptance, can be acquired. In this manner, the imaging device 3 functions as a pre-authentication acquisition device that acquires the pre-authentication information. As the pre-authentication process, examples of the face authentication and the gait acceptance have been described, but the pre-authentication process is not limited thereto. In the first example embodiment, the pre-authentication is authentication using an image captured by the imaging device 3, and authentication other than the face authentication or the gait authentication may be adopted as the pre-authentication as long as the pre-authentication is an authentication process using information that can be acquired by the imaging device 3.

In the entrance management system 1, fingerprint authentication is adopted as the authentication process (main authentication process). The reading device 5 is a device that acquires (reads) an image of a fingerprint of a finger of the person to be authenticated 10. That is, here, the reading device 5 functions as an authentication acquisition device that acquires information used in the authentication process from the person to be authenticated 10.

The display device 4 is a device that displays information transmitted from the entrance management device 2, and is installed with the height, orientation, and the like of a screen adjusted so that the person to be authenticated 10 proceeds toward the flapper gate 7 can see (read) the displayed information.

As illustrated in FIG. 1, the entrance management device 2 is connected to the imaging device 3, the display device 4, the reading device 5, the opening and closing device 6, and a database 8. The database 8 is a storage device that stores authentication registration information on a person who is permitted to enter the restricted area (hereinafter, also referred to as a registrant). Here, the authentication registration information is information for use in processes (authentication process or pre-authentication process) of determining that the user is a registrant. For example, the authentication registration information is a face image of the registrant in the case of face authentication, and is fingerprint information on the registrant in the case of fingerprint authentication. Such authentication registration information is associated with, for example, registrant identification information for identifying the registrant. In addition, the database 8 stores an entrance/exit history regarding the restricted area of the registrant in association with the registrant identification information.

The entrance management device 2 is a computer device, and includes a control device 20 and a storage device 22. The storage device 22 includes a storage medium that stores data and a computer program (hereinafter, also referred to as a program) 23. There is a plurality of types of storage devices such as a magnetic disk device and a semiconductor memory element, and there is a plurality of types of semiconductor memory elements such as a random access memory (RAM) and a read only memory (ROM). The type of the storage device 22 included in the entrance management device 2 is not limited to one. A computer device is often provided with a plurality of types of storage devices. Here, the type and number of the storage devices 22 provided in the entrance management device 2 are not limited, and the description thereof will be omitted. In addition, in a case where the entrance management device 2 includes a plurality of types of storage devices 22, they are collectively referred to as a storage device 22.

In the first example embodiment, the storage device 22 stores, as a program 23, a computer program (application) for causing the entrance management device 2 to execute processing related to entrance management of the restricted area.

The control device 20 includes a processor such as a central processing unit (CPU) or a graphics processing unit (GPU). The control device 20 can have various functions based on the program 23 by reading and executing the program 23 stored in the storage device 22. Here, the control device 20 includes a pre-authentication unit 25, a notification unit 26, an authentication unit 27, and an output unit 28 as functional units related to the entrance management system 1.

The pre-authentication unit 25 executes a pre-authentication process using pre-authentication information that is a captured image of the person to be authenticated 10 captured by the imaging device 3. That is, as the pre-authentication process, the pre-authentication unit 25 collates the image of the person to be authenticated 10, which is the pre-authentication information acquired by the imaging device 3, with information corresponding to the pre-authentication information on the registrant included in the authentication registration information in the database 8. As a specific example, in a case where the face authentication is set as the pre-authentication, the pre-authentication unit 25 collates the face image of the person to be authenticated 10, which is the pre-authentication information acquired by the imaging device 3, with a face image of the registrant in the database 8.

In the first example embodiment, timing at which the pre-authentication unit 25 starts the pre-authentication process is before the main authentication process is started, for example, timing at which the person to be authenticated 10 approaching the flapper gate 7 is detected by a captured image of the imaging device 3, a human body detection sensor, or the like.

In addition, before the pre-authentication is performed, it is necessary to perform a process of extracting the face image of the person to be authenticated 10, which is the pre-authentication information, from the captured image captured by the imaging device 3 and a process of analyzing a way of walking of the person to be authenticated 10, which is the pre-authentication information, using the captured image (moving image). Here, a method of preprocessing such pre-authentication is not limited, and description thereof will be omitted. In addition, this preprocessing may be executed by the imaging device 3 or may be executed by the entrance management device 2.

Through such collation processing, the pre-authentication unit 25 determines whether the person to be authenticated 10 is a registrant. Then, in a case where the person to be authenticated 10 is determined to be the registrant, the pre-authentication unit 25 further specifies the registrant corresponding to the person to be authenticated 10 and extracts the registrant identification information on the specified registrant as the pre-authentication process. There are various processing methods for the authentication process such as face authentication and gait authentication using information set as pre-authentication and acquired by the imaging device 3. Here, as long as it is possible to determine whether the person to be authenticated 10 is a registrant and to specify the person to be authenticated who is the registrant, the processing method is not limited, and the description thereof will be omitted.

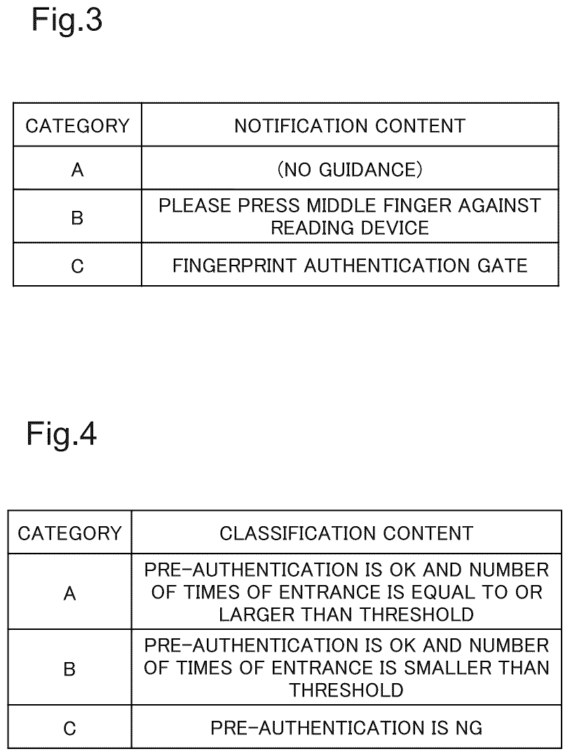

The notification unit 26 determines content to be issued to the person to be authenticated 10 by the display device 4 as the guidance information by using the authentication result by the pre-authentication unit 25. That is, the storage device 22 stores guidance notification data to be referred to when determining the notification content. FIG. 3 illustrates a specific example of the guidance notification data. In the example of FIG. 3, three types of notification contents are set as guidance information, and different categories are associated with the respective types. FIG. 4 illustrates an example of classification content of categories A, B, and C illustrated in FIG. 3. The data illustrated in FIG. 4 is also stored in the storage device 22. In a case where the data illustrated in FIGS. 3 and 4 is referred to by the notification unit 26, the notification unit 26 determines the following notification content as the content to be issued to the person to be authenticated 10. That is, in a case where the pre-authentication unit 25 determines that the person to be authenticated 10 is a registrant (pre-authentication OK), and the number of times of entrance of the person to be authenticated 10 (that is, the registrant) into the restricted area is equal to or larger than a threshold, the notification unit 26 determines not to display guidance (there is no content to be issued). The number of times of entrance is calculated from an entrance/exit history associated with the registrant identification information of the database 8 related to the person to be authenticated 10 (that is, the registrant).

In a case of determining not to display the guide, the notification unit 26 outputs information indicating that the guide is not to be displayed to the display device 4 as the guide information. In this case, the display device 4 does not display the guidance information related to the authentication process, and maintains a display off state as it is in a case where the screen display is off, or maintains the display of a landscape image as it is in a case where the landscape image indicating a waiting state or the like is displayed. That is, since the registrant whose number of times of entrance to the restricted area is equal to or larger than the threshold performs the authentication process so many times that the authentication process can be smoothly performed without the guidance regarding the authentication process (main authentication process), it is assumed that the guidance regarding the authentication process is unnecessary. Thus, the notification unit 26 determines not to notify the guidance, and outputs information indicating the determination to the display device 4 as guidance information.

Furthermore, in a case where the pre-authentication unit 25 determines that the person to be authenticated 10 is a registrant (pre-authentication OK), and the number of times of entrance of the person to be authenticated 10 into the restricted area is smaller than the threshold, the notification unit 26 determines notification content indicating “Please press the middle finger against the reading device” in the example of FIG. 3. Then, the notification unit 26 outputs information indicating the notification content to the display device 4 as guidance information. As a result, the display device 4 displays the notification content. That is, it is assumed that for the registrant whose number of times of entrance to the restricted area is smaller than the threshold, it is preferable to display information to guide the authentication process for smooth authentication process (main authentication process). Thus, the notification unit 26 outputs information leading to a smooth authentication process to the display device 4 as guidance information.

Further, in a case where the pre-authentication unit 25 determines that the person to be authenticated 10 is not a registrant (pre-authentication NG), the notification unit 26 determines predetermined notification content (“fingerprint authentication gate” in the example of FIG. 3) as the notification content in the case of the pre-authentication NG. Then, the notification unit 26 outputs information indicating the notification content to the display device 4 as guidance information. As a result, the display device 4 displays the notification content.

As described above, since the guidance information is not displayed on the display device 4 for the person to be authenticated 10 who has entered many times and is accustomed to authentication, it is possible to prevent the person to be authenticated 10 who is accustomed to authentication from becoming accustomed to a state in which the guidance information is displayed on the display device 4. As a result, for example, when information that the user is accustomed to authentication desires to gaze at is displayed on the display device 4 toward the person to be authenticated 10, the person to be authenticated 10 who is accustomed to authentication notices the display of the information and can prevent missing confirmation of the information. That is, for example, in a case where the finger used in the fingerprint authentication is changed and information for issuing the change is displayed on the display device 4, the person to be authenticated 10 who is accustomed to the authentication can confirm the display content and correctly press the changed fingerprint of the finger against the reading device 5. As a result, it is possible to reduce redoing of the operation related to the authentication process, and thus, it is possible to prevent the person to be authenticated 10 from staying in front of the flapper gate 7 due to the display oversight of the display device 4.

In addition, the display device 4 displays the content (in other words, hint on authentication) for guiding the authentication process for the person to be authenticated 10 who is not accustomed to authentication, so that the person to be authenticated 10 who is not accustomed to authentication can smoothly perform the operation for the authentication process without being confused or made a mistake.

Furthermore, the fact that the content (in other words, hint on authentication) for guiding the authentication process is not displayed on the display device 4 for the person whose pre-authentication is NG prevents information regarding the authentication process from being given to, for example, a person (attacker) trying to enter impersonating a registrant.

The authentication unit 27 executes a predetermined authentication process (main authentication process). Here, as described above, fingerprint authentication is set as the authentication process. That is, the authentication unit 27 acquires the image of the fingerprint of the finger of the person to be authenticated 10 acquired by the reading device 5, and collates the fingerprint information including a feature amount extracted from the acquired image of the fingerprint with the fingerprint information on the registrant included in the authentication registration information in the database 8 as the authentication process. Then, the authentication unit 27 determines whether to permit the person to be authenticated 10 to enter the restricted area by using the collation result. There are various processing methods of fingerprint authentication, and the processing method is not limited herein, and the description thereof will be omitted.

There is an authentication method of performing authentication in multiple stages. This authentication method is an authentication method of narrowing down candidates of registrants who are considered to be person to be authenticated while sequentially performing a plurality of authentication processes and finally specifying a registrant corresponding to the person to be authenticated, and the plurality of authentication processes is a series of processes. Here, two types of authentication processes of the pre-authentication process and the authentication process are performed, but the result of the pre-authentication process is not directly related to the authentication process (main authentication process), and is different from the multi-stage authentication as described above.

The output unit 28 outputs information indicating a result of the authentication process by the authentication unit 27. That is, in a case where the authentication unit 27 permits the person to be authenticated 10 to enter, the output unit 28 outputs information indicating that the entrance is permitted to the opening and closing device 6. As a result, the opening and closing device 6 operates to open the flapper gate 7. After that, the flapper gate 7 opened in this manner is closed by the opening and closing device 6 at a predetermined closing timing. An example of the closing timing is timing when a predetermined time has elapsed after the flapper gate 7 is opened. As another example of the closing timing, there is a timing when the passage of the person to be authenticated 10 is detected by a human body detection sensor in a case where the human body detection sensor is provided at a position where the person to be authenticated passes through the flapper gate 7.

The output unit 28 further outputs, to the database 8, information including information indicating a result of the authentication process by the authentication unit 27, a time when the authentication process has been executed, and, in a case where the person to be authenticated 10 is a registrant, registrant identification information on the registrant, to be added as an access history.

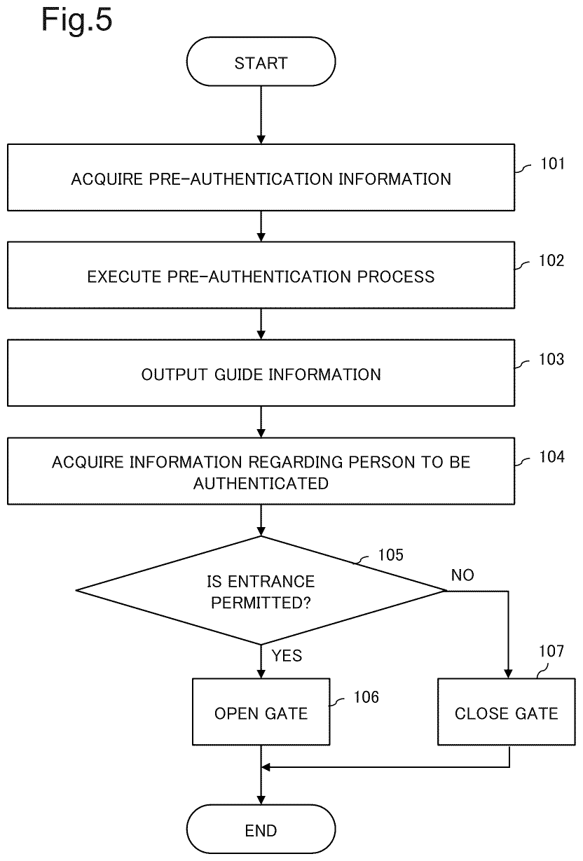

The entrance management device 2 of the first example embodiment is configured as described above. Next, an example of an operation related to the entrance management in the entrance management device 2 will be described with reference to FIG. 5. FIG. 5 is a flowchart illustrating an example of an operation related to the entrance management in the entrance management device 2.

For example, when acquiring the pre-authentication information included in an image captured by the imaging device 3 (step 101 in FIG. 5), the pre-authentication unit 25 of the entrance management device 2 executes the pre-authentication process (step 102). That is, when the person to be authenticated 10 approaching the flapper gate 7 is captured by the imaging device 3, and the pre-authentication unit 25 acquires the pre-authentication information regarding the person to be authenticated 10 included in the captured image by the imaging device 3, the pre-authentication unit 25 executes the pre-authentication process.

After the pre-authentication process is completed, the notification unit 26 uses the result of the pre-authentication process to determine, as guidance information, the content to be issued to the person to be authenticated 10 by the display device 4, and outputs the guidance information to the display device 4 (step 103). As a result, the display device 4 executes a display operation based on the guidance information.

On the other hand, when the authentication unit 27 acquires, from the reading device 5, information (in the first example embodiment, an image of a fingerprint) which is information related to the person to be authenticated 10 and is used in the authentication process (main authentication process) (step 104), the authentication unit 27 executes the authentication process. That is, the authentication unit 27 determines whether to authenticate the person to be authenticated 10 by collating the fingerprint information extracted from the image of the fingerprint of the person to be authenticated 10 with the fingerprint information on the registrant stored in the database 8, in other words, whether to permit the person to be authenticated 10 to enter the restricted area (step 105). According to this determination, in a case where the person to be authenticated 10 is permitted to enter the restricted area, it is determined to open the flapper gate 7 (step 106), and the output unit 28 outputs information indicating that the entrance is permitted to the opening and closing device 6. As a result, the flapper gate 7 is opened by the opening and closing device 6. In addition, in a case where the authentication unit 27 does not permit the person to be authenticated 10 to enter the restricted area, it is determined that a state in which the flapper gate 7 is closed is maintained (step 107), and the person to be authenticated 10 is prevented from entering.

Since the entrance management device 2 of the first example embodiment is configured as described above, the following effects can be obtained. That is, with reference to the result of the pre-authentication process, the entrance management device 2 displays the guidance information on the display device 4 for the person to be authenticated 10 who is assumed to need the guidance information for the authentication process. On the other hand, the entrance management device 2 performs display control of the display device 4 such that the guidance information is not displayed on the display device 4 for the person to be authenticated 10 who is accustomed to the authentication process and is assumed not to need the guidance information. That is, the entrance management device 2 can support the person who is not accustomed to the authentication process by the display of the display device 4 so that the person who is not accustomed to the authentication process can perform the operation for the authentication process without being confused by referring to the guide information. That is, the entrance management device 2 can prevent a situation in which a person who is not accustomed to the authentication process stops in front of the flapper gate 7 due to the fact that the person is not accustomed to the authentication process, and a person following the person (person to be authenticated) stays. Further, with respect to a person who is accustomed to the authentication process, the entrance management device 2 does not display the guidance information on the display device 4, so that it is possible to prevent the person who is accustomed to the authentication process from becoming accustomed to the guidance information being displayed on the display device 4. For this reason, as described above, for example, when the information that the user desires to watch is displayed on the display device 4 toward the person to be authenticated 10 accustomed to the authentication process, the person to be authenticated 10 accustomed to the authentication process notices the display of the information and can prevent missing confirmation of the information. That is, for example, in a case where the finger to be used in the fingerprint authentication is changed and information for issuing the change is displayed on the display device 4, the person to be authenticated 10 accustomed to the authentication process can confirm the display content and correctly press the changed fingerprint of the finger on the reading device 5. As a result, since it is possible to reduce re-doing of the operation related to the authentication process, the entrance management device 2 can prevent the person to be authenticated 10 from staying in front of the flapper gate 7 due to the display oversight of the display device 4. As described above, the entrance management device 2 can suppress the occurrence of stay of the person to be authenticated 10 in front of the flapper gate 7 by controlling the display of the display device 4.

Furthermore, in a case where it is determined that the person to be authenticated 10 is not a registrant in the pre-authentication process, the entrance management device 2 does not display guide information (in other words, hint on authentication) for guiding the authentication process on the display device 4. As a result, the entrance management device 2 prevents giving information related to the authentication process to, for example, a person (attacker) who intends to enter pretending to be a registrant.

Therefore, the entrance management device 2 can avoid the problem caused by the display of the guidance information (hint information) while having the function of displaying the guidance information (hint information) that assists a person who is not accustomed to the authentication process.

In addition, since the pre-authentication process by the pre-authentication unit 25 can be said to be a process of acquiring information used for display control of guidance information by the display device 4, the authentication accuracy may be lower than that of the authentication process by the authentication unit 27, the processing time can be shortened, and an inexpensive authentication method can be adopted.

### Second Example Embodiment

Hereinafter, a second example embodiment according to the present invention will be described. In the description of the second example embodiment, the same reference numerals are given to the same name parts as the components configuring the entrance management system of the first example embodiment, and redundant description of the common parts will be omitted.

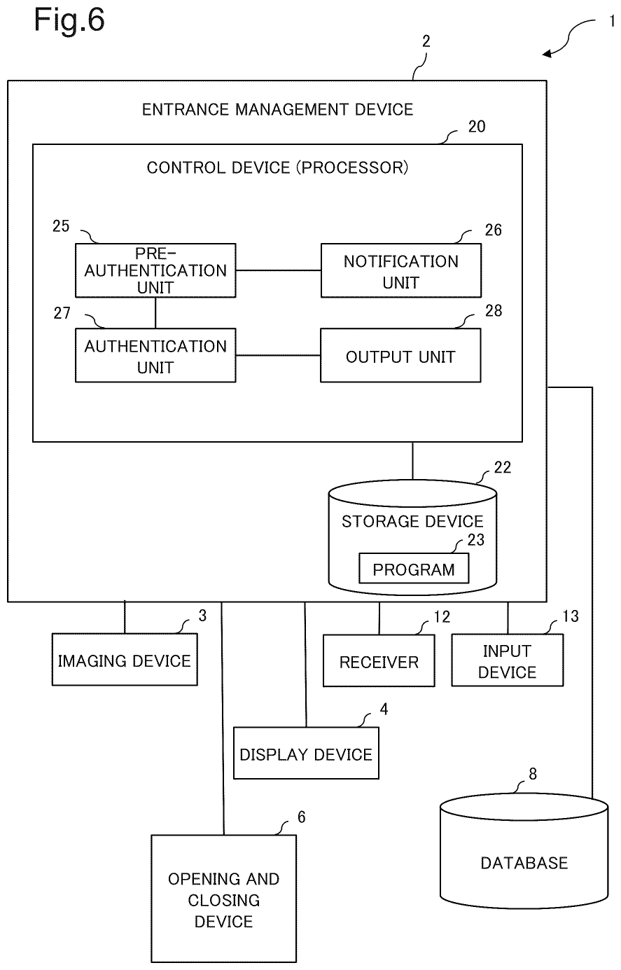

FIG. 6 is a block diagram illustrating a configuration of an entrance management device 2 according to the second example embodiment. In the second example embodiment, in an authentication process executed by an authentication unit 27, radio frequency identification (RFID) authentication is set as a main authentication process (first authentication process). Further, keypad authentication is set as the authentication process (second authentication process) of re-challenge which is the authentication process executed by the authentication unit 27 in a case where a person to be authenticated 10 is not authenticated by the RFID authentication (in the case of the authentication failure (authentication NG)). The RFID authentication is authentication in which a user identification (ID) stored in a radio frequency (RF) tag possessed by a person to be authenticated is read by a receiver 12 by an RFID technology, and an authentication process related to the person to be authenticated 10 is performed using the read user ID. The keypad authentication is authentication in which, for example, a user ID and a password of the person to be authenticated 10 are acquired by an input device 13 such as a keyboard and a touch panel, and an authentication process related to the person to be authenticated 10 is performed using the acquired user ID and the password.

That is, in the second example embodiment, the receiver 12 and the input device 13 are installed near a flapper gate 7 installed at the entrance of a restricted area. The entrance management device 2 of the second example embodiment is connected to each of the receiver 12 and the input device 13. In the second example embodiment, since fingerprint authentication is not performed, a reading device 5 that acquires the fingerprint image shown in the first example embodiment is omitted. Further, in the second example embodiment, an image capturing range of the imaging device 3 is set so as to be able to capture the plurality of persons to be authenticated 10 approaching the flapper gate 7.

The authentication unit 27 of the entrance management device 2 can execute the RFID authentication using the user ID received by the receiver 12 and the keypad authentication using the user ID and the password input by the input device 13.

In the second example embodiment, a display device 4 displays guidance information for guiding the person to be authenticated 10 to the keypad authentication in a case where the person to be authenticated 10 is not authenticated by the RFID authentication. The pre-authentication unit 25 executes the pre-authentication process so as to provide the notification unit 26 with information related to the display control of the guidance information on the display device 4. That is, the pre-authentication unit 25 starts the pre-authentication process in response to a fact that the authentication unit 27 detects that the person to be authenticated 10 is not authenticated by the RFID authentication. The pre-authentication unit 25 executes the pre-authentication process for the person to be authenticated 10 captured in the captured image using the pre-authentication information acquirable from the captured image by the imaging device 3. In the second example embodiment, the image capturing range of the imaging device 3 is set so as to be able to capture a plurality of persons to be authenticated 10 approaching the flapper gate 7. Therefore, in a case where a plurality of persons to be authenticated 10 is captured in the same captured image, the pre-authentication unit 25 determines whether each of the persons to be authenticated 10 is a registrant. In addition, the pre-authentication unit 25 detects the number of persons to be authenticated 10 (hereinafter, also referred to as the number of waiting persons) captured in the same captured image. Other configurations of the pre-authentication unit 25 in the second example embodiment are similar to those in the first example embodiment.

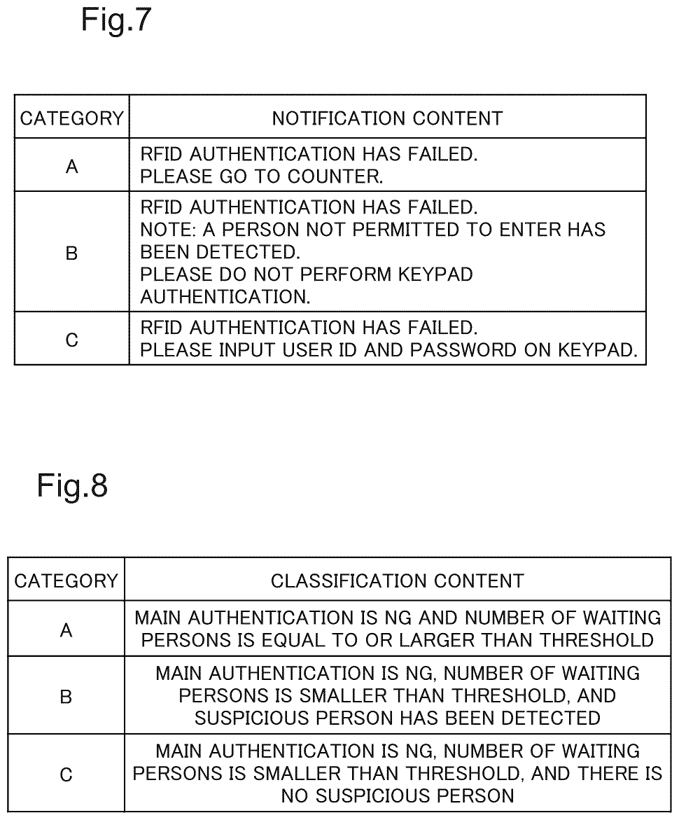

In the second example embodiment, the notification unit 26 determine the content to be issued to the person to be authenticated 10 by the display device 4 as the guidance information by using the result of the processing by the pre-authentication unit 25 and the data as illustrated in FIGS. 7 and 8. Data referred to by the pre-authentication unit 25 as illustrated in FIGS. 7 and 8 is stored in the storage device 22.

Here, a specific example of the notification content of the guidance information determined by the notification unit 26 in a case of referring to a result of processing by the pre-authentication unit 25 and the data illustrated in FIGS. 7 and 8 will be described. That is, in a case where the main authentication (RFID authentication) by the authentication unit 27 is NG and the number of waiting persons of the persons to be authenticated 10 captured in the captured image is equal to or larger than the threshold (category A), “RFID authentication has failed. Please go to the counter” is determined by the notification unit 26. The threshold here is a determination reference value for determining whether a front of the flapper gate 7 is crowded with the persons to be authenticated 10.

In a crowded situation, an interval between one person to be authenticated 10 and another person to be authenticated 10 is narrowed. Therefore, when the person to be authenticated 10 (here, a target person A) inputs a password or the like to the input device 13 for keypad authentication, another person to be authenticated 10 (here, a target person B) may be able to read the password of the target person A from the input operation. For this reason, it is considered that the keypad authentication is not preferable in the crowded situation. As a result, in a situation where the number of waiting persons is equal to or larger than the threshold and it is congested, in a case where the RFID authentication has failed, the authentication process of re-challenge is not executed, and a notification for guiding the person to be authenticated 10 to the counter (that is, attendance by staff) is displayed on the display device 4.

In addition, there is a case where the main authentication (RFID authentication) by the authentication unit 27 is NG, and it is determined that a person (suspicious person) determined not to be a registrant by the pre-authentication is included among the plurality of persons to be authenticated 10 captured in the captured image (category B). In this case, “RFID authentication has failed. Note: A person who is not permitted to enter has been detected. Please do not perform keypad authentication” is determined by the notification unit 26. In this case, it is assumed that the RFID authentication fails and a suspicious person is near the person to be authenticated 10 who is the target person of the re-challenge authentication. In this case, when a password or the like is input to the input device 13 for keypad authentication, the password may be read by the suspicious person. For this reason, notification content for issuing this are determined by the notification unit 26.

Furthermore, a situation (category C) in which it is assumed that the main authentication (RFID authentication) by the authentication unit 27 is NG, the periphery of the person to be authenticated 10 is not congested, and no suspicious person is seen nearby is considered. In this case, “RFID authentication has failed. Please input the user ID and the password on the keypad” is determined by the notification unit 26.

The notification content determined in this manner is output from the notification unit 26 to the display device 4 as the guidance information. As a result, the display device 4 displays the notification content. That is, in the second example embodiment, the display device 4 does not display information when the person to be authenticated 10 performs the RFID authentication which is the main authentication process by the authentication unit 27, and displays the guidance information in a case where the RFID authentication is NG. As a result, in the second example embodiment, similarly to the first example embodiment, it is possible to prevent a person who is accustomed to the authentication process from becoming accustomed to the display of the display device 4. Therefore, in a case where information is displayed on the display device 4, both a person who is accustomed to the authentication process and a person who is not accustomed to the authentication process pay attention to the displayed information, and it is possible to prevent the person to be authenticated 10 from staying in front of the flapper gate 7 due to overlooking of the displayed information.

In the second example embodiment, in a case where the notification content as described in the above-described specific example are determined by the notification unit 26, the notification unit 26 also outputs information indicating such notification content to the authentication unit 27. Accordingly, in a case of receiving the information of the notification content corresponding to the category A or the category B illustrated in FIG. 7 from the notification unit 26, the authentication unit 27 does not receive an input for keypad authentication, for example.

The configuration other than the above in entrance management device 2 of the second example embodiment is similar to the configuration of the entrance management device 2 of the first example embodiment.

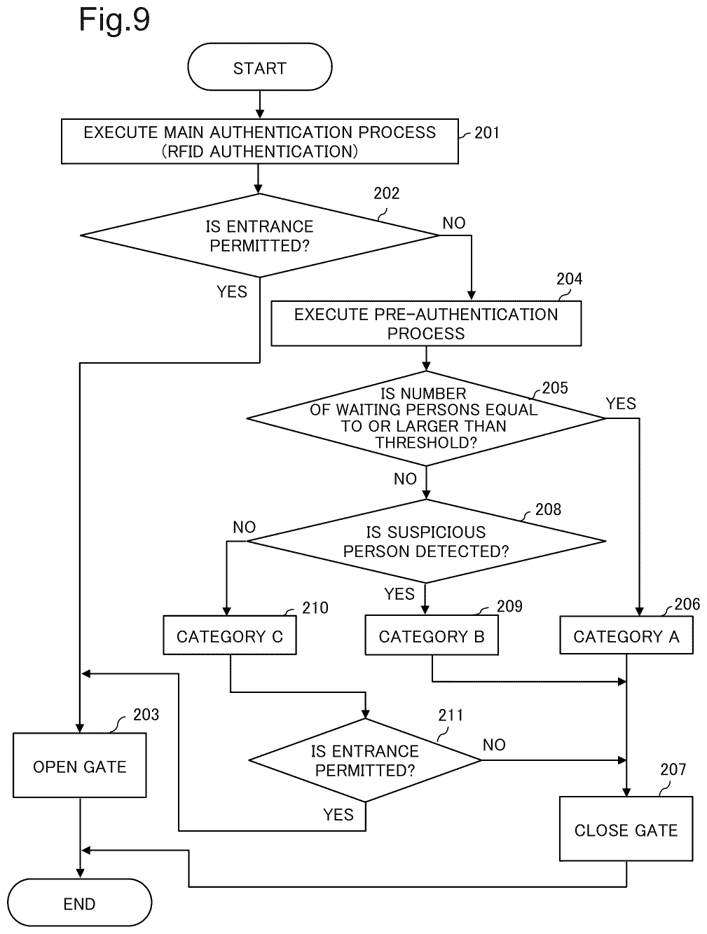

Next, an example of an operation related to the entrance management in the entrance management device 2 according to the second example embodiment will be described with reference to FIG. 9. FIG. 9 is a flowchart illustrating an example of an operation related to entrance management in entrance management device 2.

For example, when the receiver 12 receives the user ID from the RF tag of the person to be authenticated 10, the authentication unit 27 executes RFID authentication which is the main authentication process for the person to be authenticated 10 (step 201 in FIG. 9). As a result, it is determined whether to permit the person to be authenticated 10 to enter the restricted area (step 202). In a case where the entrance is permitted, it is determined to open the flapper gate 7 (step 203), and the output unit 28 outputs information indicating that the entrance is permitted to the opening and closing device 6. As a result, the flapper gate 7 is opened by the opening and closing device 6.

On the other hand, in a case where the entrance is not permitted in step 202, the pre-authentication unit 25 executes the pre-authentication process (step 204). Thereafter, the notification unit 26 determines whether the number of waiting persons detected by the processing of the pre-authentication unit 25 is equal to or larger than a threshold (step 205). If it is determined by this determination that the number of waiting persons is equal to or larger than the threshold, the notification unit 26 refers to the data illustrated in FIG. 7 and determines a notification content corresponding to the category A such as “RFID authentication has failed. Please go to the counter” (step 206). Then, the notification unit 26 outputs information indicating the notification content to the display device 4. As a result, the notification content is displayed by the display device 4. In this case, the entrance management device 2 maintains a state where the flapper gate 7 is closed (step 207).

If it is determined in step 205 that the number of waiting persons is not equal to or larger than the threshold (the number of waiting persons is smaller than the threshold), the notification unit 26 further refers to the authentication result by the pre-authentication unit 25, and determines whether a suspicious person (that is, a person who is determined not to be a registrant in the pre-authentication process) has been detected in the captured image (step 208). As a result, in a case where it is determined that the suspicious person has been detected, the notification unit 26 refers to the data illustrated in FIG. 7 and determines a notification content corresponding to the category B indicating “RFID authentication has failed. Note: A person who is not permitted to enter has been detected. Please do not perform keypad authentication” (step 209). Then, the notification unit 26 outputs information indicating the notification content to the display device 4. As a result, the notification content is displayed by the display device 4. Furthermore, in this case, the entrance management device 2 maintains a state where the flapper gate 7 is closed (step 207).

Furthermore, in a case where it is determined in step 208 that the suspicious person has not been detected, the notification unit 26 refers to the data illustrated in FIG. 7 and determines a notification content corresponding to the category C such as “RFID authentication has failed. Please input the user ID and the password on the keypad” (step 210). Then, the notification unit 26 outputs information indicating the notification content to the display device 4. As a result, the notification content is displayed by the display device 4.

Thereafter, when receiving the user ID and the password input by the person to be authenticated 10 using the input device 13, the authentication unit 27 executes the keypad authentication using the received user ID and the password. That is, the authentication unit 27 determines whether to permit the entrance of the person to be authenticated 10, who has input the user ID and the password, into the restricted area (step 211). In a case where the entrance has not been permitted by the keypad authentication, the entrance management device 2 maintains a state where the flapper gate 7 is closed (Step 207). On the other hand, in a case where the entrance is permitted in step 211, it is determined to open the flapper gate 7 (step 203), and the output unit 28 outputs information indicating that the entrance is permitted to the opening and closing device 6. As a result, the flapper gate 7 is opened by the opening and closing device 6.

Since the entrance management device 2 of the second example embodiment is configured as described above, it is possible to prevent the stay of the person to be authenticated 10 due to the display of the display device 4, and it is possible to prevent the suspicious person from acquiring information for impersonating the registrant as described above.

### Other Example Embodiments

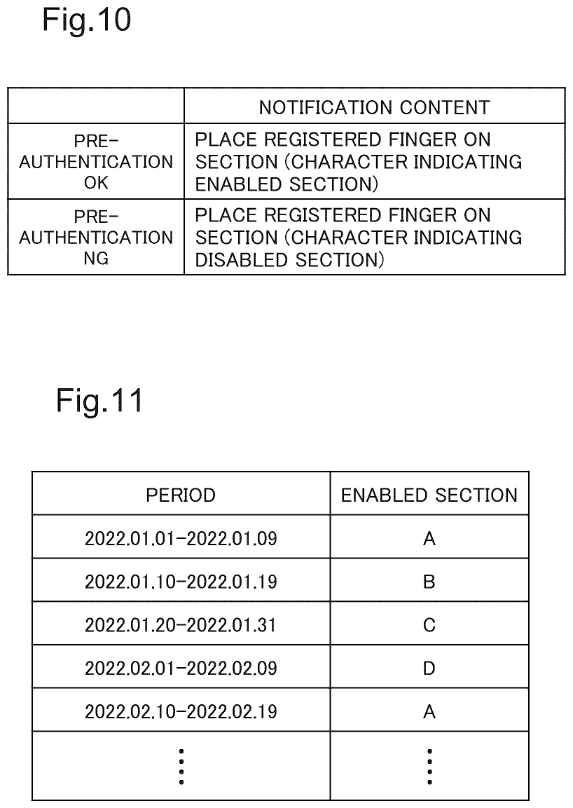

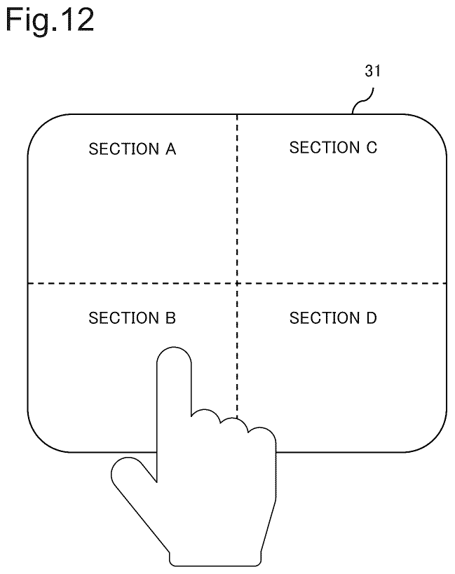

The present invention is not limited to the first example embodiment and the second example embodiment, and various example embodiments can be adopted. For example, in the first example embodiment, the notification unit 26 refers to the data as illustrated in FIGS. 3 and 4 and the authentication result by the pre-authentication unit 25, and determines the content to be issued to the person to be authenticated 10 by the display device 4. Instead of this, the notification unit 26 may determine the content to be issued to the person to be authenticated 10 by the display device 4 with reference to the data illustrated in FIGS. 10 and 9 and the authentication result by the pre-authentication unit 25. That is, the authentication unit 27 performs the fingerprint authentication as the main authentication process, and the reading device 5 includes a pad on which a finger is placed to capture an image of the fingerprint of the person to be authenticated 10. Here, as illustrated in FIG. 12, a surface of the pad 31 (the surface on which the finger is placed) has a larger area than the finger of the person to be authenticated 10, and is divided into, for example, four sections A to D. When referring to the data illustrated in FIGS. 10 and 9 and the authentication result by the pre-authentication unit 25, the notification unit 26 determines the content to be issued to the person to be authenticated 10 by the display device 4 as follows. That is, the notification unit 26 detects an enabled section based on date on which the pre-authentication process has been executed by the pre-authentication unit 25 and data illustrated in FIG. 11. For example, in this description, it is assumed that the enabled section is “B”. Then, in a case where the pre-authentication unit 25 determines that the person to be authenticated 10 is a registrant (pre-authentication OK), the notification unit 26 refers to the data illustrated in FIG. 10 and determines notification content (correct hint) indicating that “Place registered finger on section B”. In addition, in a case where the pre-authentication unit 25 determines that the person to be authenticated 10 is not a registrant (pre-authentication NG), the notification unit 26 refers to the data illustrated in FIG. 10 and determines notification content (wrong hint) indicating that “Place registered finger on section C”.

In this manner, the guidance information indicating the notification content determined by the notification unit 26 is output toward the display device 4 and displayed by the display device 4. The authentication unit 27 executes the fingerprint authentication, which is the main authentication process, using the fingerprint image of the finger captured at a position of the enabled section B of the pad in the reading device 5. In addition, the authentication unit 27 does not execute the fingerprint authentication in a case where the fingerprint of the finger is captured at the position of the section A, the section C, or the section D which is not the enabled section B of the pad in the reading device 5.

In the example of FIG. 11, the enabled sections are determined by the date, but for example, different enabled sections may be set depending on a time zone of one day.

In the first example embodiment and the second example embodiment, the authentication process using the captured image captured by the imaging device 3 is set as the pre-authentication process. However, the pre-authentication process is not limited to the authentication process using the captured image, and an appropriate authentication process may be adopted.

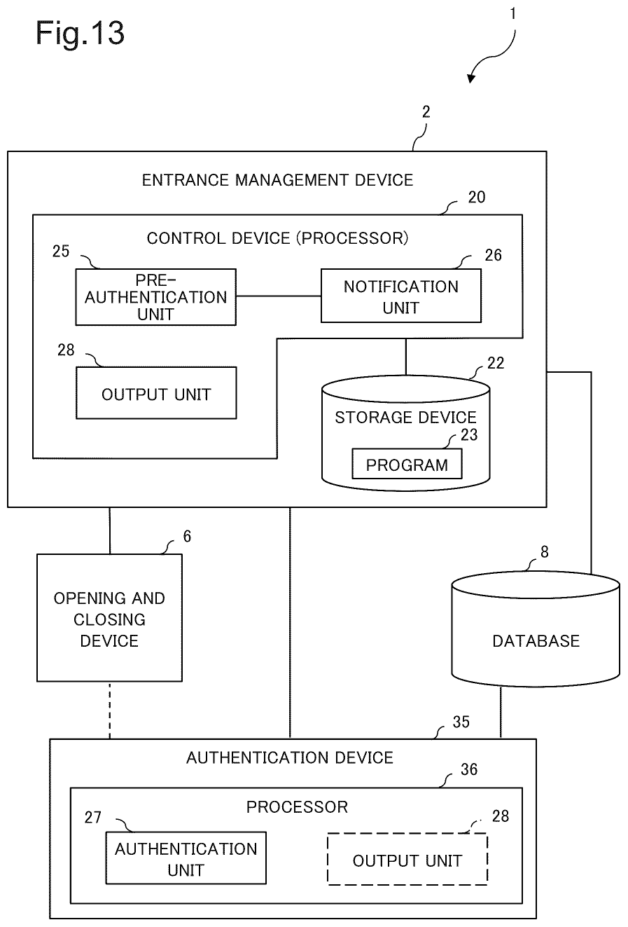

Furthermore, in the first example embodiment and the second example embodiment, the control device 20 of the entrance management device 2 includes the authentication unit 27. Alternatively, for example, as illustrated in FIG. 13, authentication unit 27 may be provided in the authentication device 35 different from the entrance management device 2. Also in this case, similarly to the first and second example embodiments, the authentication unit 27 is executed as a functional unit of the processor 36 by the processor 36 included in the authentication device (computer device) 35 executing a computer program. In this case, the authentication device 35 is connected to the reading device 5 as described in the first example embodiment or the receiver 12 and the input device 13 as described in the second example embodiment (in FIG. 13, the reading device 5, the receiver 12, and the input device 13 are not illustrated). In other words, the entrance management device 2 may not be connected to the reading device 5, the receiver 12, or the input device 13. The authentication unit 27 of the authentication device 35 executes the similar authentication process to that as described in the first and second example embodiments by using the information acquired from the reading device 5 or the information acquired from the receiver 12 and the input device 13 and the information of the database 8. The authentication result is output from authentication device 35 to the entrance management device 2. In a case where the authentication result indicates that the entrance of the person to be authenticated 10 into the restricted area is permitted, the output unit 28 of the entrance management device 2 outputs information indicating that the entrance is permitted to the opening and closing device 6. As a result, the opening and closing device 6 operates to open the flapper gate 7.

Further, the authentication device 35 may include an output unit 28 as indicated by a dotted line in FIG. 13. In this case, the output unit 28 in the control device 20 of the entrance management device 2 is omitted, and in a case where the authentication unit 27 permits the person to be authenticated 10 to enter the restricted area, information indicating that the entrance is permitted is output from the output unit 28 of the authentication device 35 toward the opening and closing device 6.

Furthermore, examples of fingerprint authentication, RFID authentication, and keypad authentication have been described as the authentication process (main authentication process) executed by the authentication unit 27, but the authentication process executed by the authentication unit 27 is not limited thereto, and may be, for example, face authentication. For example, it is assumed that the authentication process (main authentication process) executed by the authentication unit 27 in the first example embodiment is face authentication. In addition, it is assumed that it is determined that the person to be authenticated 10 is not the registrant due to the face facing sideways by the face authentication by the pre-authentication unit 25. In such a case, the notification unit 26 may output, to the display device 4, information for displaying “Please face the front” as the guidance information. In addition, it is assumed that the person to be authenticated 10 is determined not to be the registrant due to wearing a mask or sunglasses by the face authentication by the pre-authentication unit 25. In such a case, the notification unit 26 may output, for example, information for displaying “Please remove mask and sunglasses” as the guidance information to the display device 4. Such guidance information displayed on the display device 4 can suppress the occurrence of a situation in which the entrance to the restricted area is not permitted even though the person to be authenticated 10 is the registrant in the face authentication by the authentication unit 27 due to the face facing sideways or wearing a mask or sunglasses. A method of detecting, by the pre-authentication unit 25, that the face of the person to be authenticated 10 is sideways or that the person to be authenticated 10 wears a mask, sunglasses, or the like from the captured image is not limited here, and the description thereof will be omitted.

Further, in the first example embodiment and the second example embodiment, authentication registration information (information including registration information for pre-authentication and registration information for authentication) is stored in the database 8 different from the entrance management device 2, and the entrance management device 2 acquires the authentication registration information from the database 8. Alternatively, the authentication registration information may be stored in the storage device 22 as a database configuring the entrance management device 2.

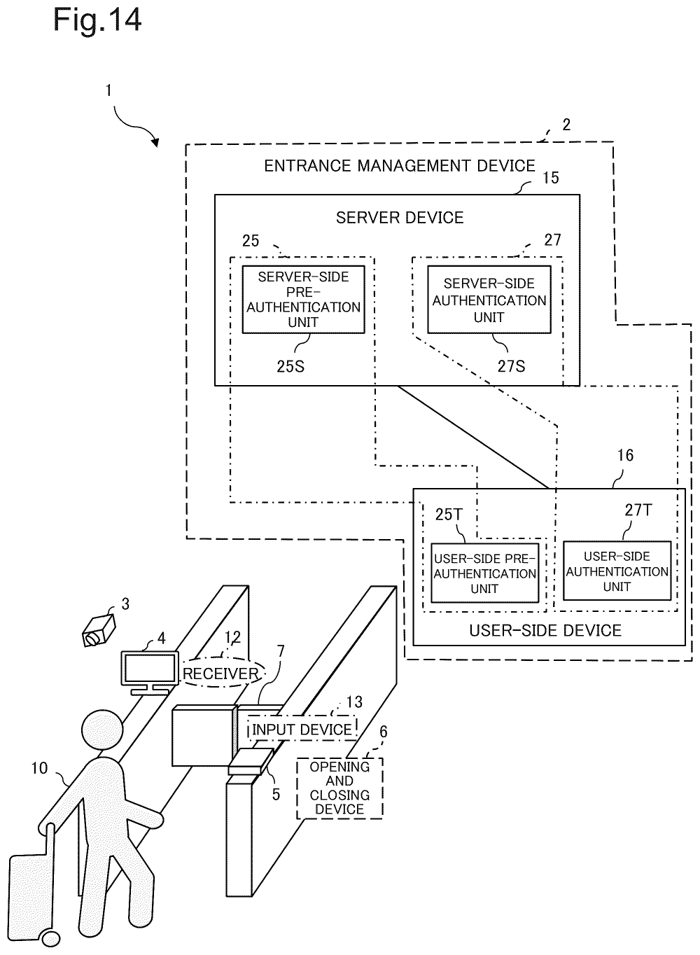

Furthermore, the entrance management device 2 may have a configuration as illustrated in FIG. 14. That is, the entrance management device 2 may include a server device 15 and a user-side device 16. The user-side device 16 is, for example, a computer device and is provided near the flapper gate 7. Furthermore, the user-side device 16 is connected to the imaging device 3, the display device 4, and the opening and closing device 6, and is further connected to the reading device 5, the receiver 12, and the input device 13. The user-side device 16 can have various functions based on a computer program when a control device including a processor such as a CPU reads the computer program from the storage device and executes the computer program. In this example, the control device of the user-side device 16 includes, as functional units, a user-side pre-authentication unit 25T and a user-side authentication unit 27T, and further includes, although not illustrated, a notification unit 26 and an output unit 28 as described in the first and second example embodiments. The user-side device 16 is connected to the server device 15 through, for example, an information communication network. The server device 15 may be a computer device dedicated to the entrance management system 1 (entrance management device 2), or may be a computer device used for other systems. The server device 15 includes a server-side pre-authentication unit 25S and a server-side authentication unit 27S as functional units executed by a processor such as a CPU executing a computer program.

In this example, the user-side pre-authentication unit 25T and the server-side pre-authentication unit 25S operate in cooperation with each other, so that the function of the pre-authentication unit 25 as described in the first and second example embodiments is executed. For example, when acquiring the image of the person to be authenticated 10 which is the information for pre-authentication acquired by the imaging device 3, the user-side pre-authentication unit 25T transmits the image of the person to be authenticated 10 to the server-side pre-authentication unit 25S. The server-side pre-authentication unit 25S executes the pre-authentication process by collating the image of the person to be authenticated 10 received from the user side pre-authentication unit 25T with information corresponding to the pre-authentication information on the registrant included in the authentication registration information in the database 8. Then, the server-side pre-authentication unit 25S transmits the result of the pre-authentication process to the user side pre-authentication unit 25T. The notification unit 26 of the user-side device 16 uses the result of the pre-authentication process received by the user-side pre-authentication unit 25T to determine, as the guidance information, the content to be issued to the person to be authenticated 10 by the display device 4, as in the first and second example embodiments.

As described in the first example embodiment, preprocessing of the pre-authentication process may be performed. Which one of the user-side pre-authentication unit 25T and the server-side pre-authentication unit 25S executes the pre-processing of the pre-authentication process may be appropriately set.

Furthermore, in the example illustrated in FIG. 14, the user-side authentication unit 27T and the server-side authentication unit 27S operate in cooperation, so that the function of the authentication unit 27 as described in the first and second example embodiments is executed. For example, when acquiring the information for the main authentication process acquired by the reading device 5, the receiver 12, or the input device 13, the user-side authentication unit 27T transmits the information to the server-side authentication unit 27S. The server-side authentication unit 27S executes the main authentication process by collating the information received from the user-side authentication unit 27T with the information on the registrant included in the authentication registration information in the database 8. Then, the server-side authentication unit 27S transmits the result of the main authentication process to the user-side authentication unit 27T.

In the above-described example, the configuration in which the user-side device 16 is connected to the imaging device 3, the reading device 5, the receiver 12, or the input device 13 has been described, but at least one of them may be connected to the server device 15. That is, information used in the pre-authentication process or the main authentication process from at least one of the imaging device 3, the reading device 5, the receiver 12, and the input device 13 may be acquired by the server device 15 without passing through the user-side device 16. In this case, the amount of communication between the user-side device 16 and the server device 15 can be reduced by the amount of information not transmitted from the user-side device 16 to the server device 15.

Furthermore, in the example of FIG. 14, an example has been described in which the pre-authentication unit 25 is achieved by the user-side pre-authentication unit 25T and the server-side pre-authentication unit 25S, and the authentication unit 27 is achieved by the user-side authentication unit 27T and the server-side authentication unit 27S. Alternatively, one of the pre-authentication unit 25 and the authentication unit 27 may include the pre-authentication unit 25 or the authentication unit 27 similar to those in the first and second example embodiments in the user-side device 16 without providing a part of the functions in the server device 15.

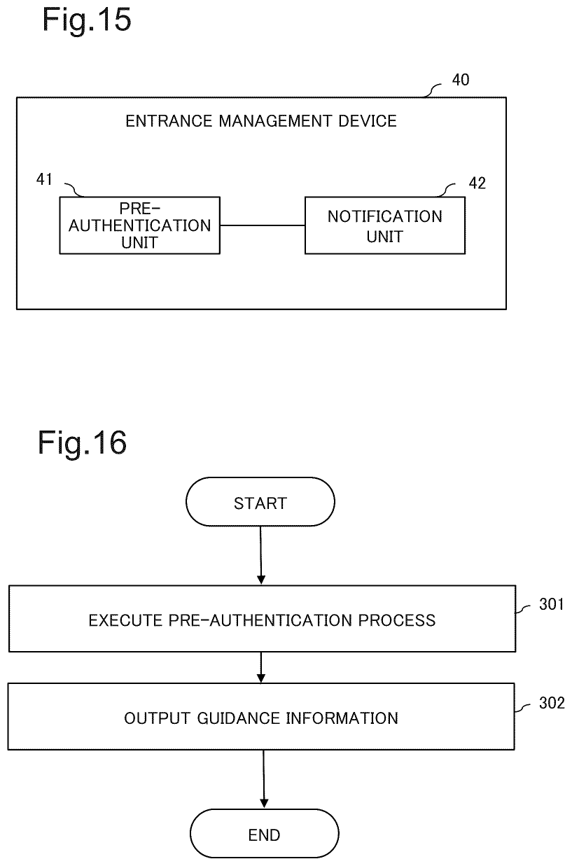

FIG. 15 is a block diagram illustrating a minimum configuration of the entrance management device according to the present invention. An entrance management device 40 illustrated in FIG. 15 is, for example, a computer device, and includes a pre-authentication unit 41 and a notification unit 42 as functional units by executing a computer program. The pre-authentication unit 41 executes a pre-authentication process of determining whether the person to be authenticated is a registrant by collating the pre-authentication information related to the person to be authenticated with the pre-authentication registration information stored in the database. Here, the person to be authenticated is a person for whom it is determined whether the person can enter a restricted area. The registrant is a person who is permitted to enter the restricted area.

The notification unit 42 determines the content to be issued to the authentication target person as the guidance information using the result of the pre-authentication process and outputs the guidance information to the display device that displays the guidance information. The guidance information is information related to the authentication process of determining whether the person to be authenticated can enter the restricted area.

Next, an example of operation related to the entrance management in the entrance management device 40 will be described with reference to FIG. 16. FIG. 16 is a flowchart illustrating an example of an operation related to the entrance management in the entrance management device 40.

For example, when the person to be authenticated approaches the entrance of the restricted area, the pre-authentication unit 41 executes the pre-authentication process using the pre-authentication information acquired by the pre-authentication acquisition device and the registration information for the pre-authentication in the database (step 301). Then, the notification unit 42 determines contents to be issued to the person to be authenticated by using a result of the pre-authentication process, and outputs the determined notification content to the display device as guidance information (step 302).

The entrance management device 40 illustrated in FIG. 15 is configured as described above. The entrance management device 40 does not make the content of the guidance information displayed on the display device the same for any person to be authenticated, but makes the content according to the result of the pre-authentication process. That is, the entrance management device 40 can detect, by the pre-authentication process, a person to be authenticated who is considered to be permitted to enter the restricted area by the authentication process, and can control the display of the display device such that the person to be authenticated can avoid overlooking the display of the display device due to habituation of authentication. As a result, the entrance management device 40 can prevent a situation in which the person to be authenticated stops at the entrance of the restricted area due to overlooking of the display on the display device and the person to be authenticated stays. In addition, the entrance management device 40 can detect a person to be authenticated (that is, the suspicious person) who is considered not to be permitted to enter the restricted area by the authentication process by the pre-authentication process and control the display of the display device so as to deal with the suspicious person. As a result, the entrance management device 40 can prevent, for example, a situation in which information (that is, information for allowing entrance into the restricted area) for obtaining authentication in the authentication process is read by the suspicious person from the display of the display device. Therefore, the entrance management device 40 can achieve an effect of being able to avoid a problem caused by the display of the guidance information (hint information) while having a function of displaying the guidance information (hint information) that assists a person who is not accustomed to the authentication process.

### REFERENCE SIGNS LIST

2, 40 entrance management device
3 imaging device
4 display device
5 reading device
7 flapper gate
8 database
10 person to be authenticated
12 receiver
13 input device
25, 41 pre-authentication unit
26, 42 notification unit
27, 43 authentication unit
28, 44 output unit

What is claimed is:

1. An entrance management device comprising:
a memory configured to store instructions; and
at least one processor configured to execute the instructions to:
execute a pre-authentication process of determining whether a person to be authenticated is a registrant by collating pre-authentication information related to the person to be authenticated for whom it is determined whether the person can enter a restricted area with pre-authentication registration information stored in a database storing authentication registration information indicating the registrant who is permitted to enter the restricted area; and
determine, as guidance information, content to be issued to the person to be authenticated regarding an authentication process of determining whether the person to be authenticated can enter the restricted area, by using a result of the pre-authentication process, and output the guidance information toward a display device that displays the guidance information.

2. The entrance management device according to claim 1, wherein
the at least one processor is further configured to execute the instructions to:
determine whether the person to be authenticated can enter the restricted area by using the information acquired by an authentication acquisition device that acquires information used in the authentication process from the person to be authenticated and the authentication registration information stored in the database; and
output a determination result as to whether the person to be authenticated can enter the restricted area.

3. The entrance management device according to claim 1, wherein
the at least one processor is configured to execute the instructions to output information indicating that there is no content to be issued to the display device as the guidance information in a case where it is determined that the person to be authenticated is the registrant in the pre-authentication process.

4. The entrance management device according to claim 1, wherein
the at least one processor is configured to execute the instructions to determine content to be issued to the person to be authenticated by also using a number of times of entrance in which the person to be authenticated enters the restricted area.

5. The entrance management device according to claim 2, wherein
the at least one processor is further configured to execute the instructions to perform a first authentication process and a second authentication process which is different from the first authentication process and is executed in a case where the entrance of the person to be authenticated into the restricted area is not permitted in the first authentication process,
the at least one processor is further configured to execute the instructions to:
execute the pre-authentication process in a case where the entrance of the person to be authenticated into the restricted area is not permitted in the first authentication process, and
determine content to be issued to the person to be authenticated as the guidance information by using a result of the pre-authentication process and outputs the guidance information to the display device.

6. The entrance management device according to claim 1, wherein
the at least one processor is further configured to execute the instructions to output correct information regarding the authentication process to the display device as the guidance information in a case where it is determined that the person to be authenticated is the registrant in the pre-authentication process, and output incorrect information regarding the authentication process to the display device as the guidance information in a case where it is determined that the person to be authenticated is not the registrant in the pre-authentication process.

7. The entrance management device according to claim 1,
the pre-authentication process is an authentication process using a captured image captured by an imaging device that captures an image of the person to be authenticated.

8. An entrance management method, comprising:
by means of a computer,
executing a pre-authentication process of determining whether a person to be authenticated is a registrant by collating pre-authentication information related to the person to be authenticated for whom it is determined whether the person can enter a restricted area with pre-authentication registration information stored in a database storing authentication registration information indicating the registrant who is permitted to enter the restricted area; and
determining, as guidance information, content to be issued to the person to be authenticated regarding an authentication process of determining whether the person to be authenticated can enter the restricted area, by using a result of the pre-authentication process, and outputting the guidance information toward a display device that displays the guidance information.

9. A non-transitory program storage medium storing a computer program for causing a computer to perform:
executing a pre-authentication process of determining whether a person to be authenticated is a registrant by collating pre-authentication information related to the person to be authenticated for whom it is determined whether the person can enter a restricted area with pre-authentication registration information stored in a database storing authentication registration information indicating the registrant who is permitted to enter the restricted area; and
determining, as guidance information, content to be issued to the person to be authenticated regarding an authentication process of determining whether the person to be authenticated can enter the restricted area, by using a result of the pre-authentication process, and outputting the guidance information toward a display device that displays the guidance information.
